(19) United States
(12) Patent Application Publication
(10) Pub. No.: US 2011/0060655 A1
(43) Pub. Date: Mar. 10, 2011

(54) Currency Market Utilizing Precious Metals and Gemstones

(76) Inventors: Damian Novak, Minneapolis, MN (US); David Pomije, Shakopee, MN (US)

(21) Appl. No.: 12/852,000

(22) Filed: Aug. 6, 2010

Related U.S. Application Data
(60) Provisional application No. 61/231,886, filed on Aug. 6, 2009.

(51) Int. Cl. G06Q 30/00

(52) U.S. Cl. 705/26.1

(57) ABSTRACT

Systems and methods for purchasing jewelry can include accepting jewelry from an individual, and evaluating the jewelry to generate a bid using an automated evaluation process including: accepting input of a plurality of attributes associated with the jewelry; and accessing a database to set the bid for the jewelry. Methods also include providing the bid to the individual, and, if acceptance of the bid is received from the individual, assuming ownership of the jewelry, and paying the individual for the jewelry. If denial of the bid is received from the individual, returning the jewelry to the individual.

### RELATED APPLICATION

This application claims the benefit of U.S. Patent Application Ser. No. 61/231,886 filed on Aug. 6, 2009, the entirety of which is hereby incorporated by reference.

### BACKGROUND

Many individuals periodically wish to convert property into liquid assets to make purchases. For example, a portion of an individual's assets can be tied up in property that is not easily liquidated to provide resources to meet the individual's needs. This potentially leaves the individual in a position in which the individual would like to liquidate property, such as jewelry. However, it can be difficult for an individual to find a fair price for such property and to go through the liquidation process.

### SUMMARY

In one aspect, an example method for facilitating trading in precious metals and gemstones includes: accepting one or more precious metals or gemstones from an individual; evaluating the precious metals or gemstones to generate a bid using an automated evaluation process; providing the bid to the individual; if acceptance of the bid is received from the individual: assuming ownership of the precious metals or gemstones; paying the individual for the precious metals or gemstones; and if denial of the bid is received from the individual, returning the precious metals or gemstones to the individual.

In another aspect, an example method for purchasing jewelry includes: accepting jewelry from an individual; evaluating the jewelry to generate a bid using an automated evaluation process including: accepting input of a plurality of attributes associated with the jewelry; and accessing a database to set the bid for the jewelry; providing the bid to the individual; if acceptance of the bid is received from the individual: assuming ownership of the jewelry; and paying the individual for the jewelry; and if denial of the bid is received from the individual, returning the jewelry to the individual.

In yet another aspect, an example computer-readable data storage medium storing computer-readable includes instructions that, when executed by one or more processing units of a computing system, cause the computing system to: accept input of a plurality of attributes associated with the jewelry; access a database to set a bid for the jewelry; and provide the bid for purchase of the jewelry.

### DESCRIPTION OF THE DRAWINGS

FIG. 1 shows an example system for liquidating jewelry.

FIG. 2 shows an example graphical user interface for evaluating jewelry.

FIG. 3 shows another example graphical user interface for evaluating jewelry.

FIG. 4 shows another example graphical user interface for evaluating jewelry.

FIG. 5 shows another example graphical user interface for evaluating jewelry.

FIG. 6 shows an example method for liquidating jewelry.

FIG. 7 shows another example system for liquidating jewelry.

FIG. 8 shows another example graphical user interface for evaluating jewelry.

FIG. 9 shows another example graphical user interface for evaluating jewelry.

### DESCRIPTION

In example embodiments described herein, a currency market 100 is created to allow individuals to use convert precious metals and/or gemstones (sometimes referred to herein as “jewelry”) into liquid assets that can be used to purchase products or services or to satisfy a portion or all of a debt.

In some examples described herein, the examples described herein allow individuals to convert jewelry into liquid assets that can be used to pay a debt. In other examples, similar examples are disclosed that allow individuals to convert jewelry into liquid assets, such as currency, that can be used to purchase any desired goods or services.

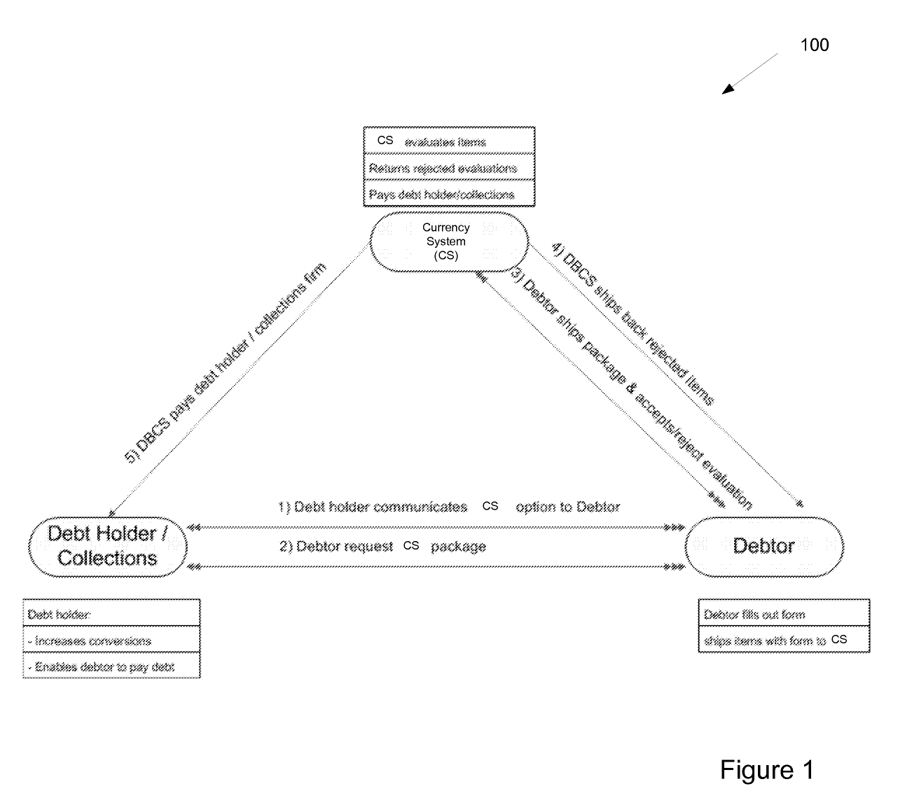

In one example shown in FIG. 1, the market 100 includes a debtor, a debt holder to which the debtor owes an obligation, and a currency system. The currency system provides collection agencies and debt holders another method for their debtors to satisfy all or part of their debt.

When a debtor is contacted through mail (electronic or otherwise), voice, in person, or fax an option to pay with diamonds, gem stones, or precious metals will be presented. If the debtor opts for this payment option, a currency system payment package is sent to the debtor and the currency system will record the package's tracking number and wait for deliver into the evaluation center. The package will have a barcode that contains the debt holder and debtor identification. A form will be included for the debtor to fill out their contact information. The debtor will place their items to be included for payment in the package. The debtor will ship the package to the evaluation center associated with the currency system.

Once the evaluation center has received the debtor's items, the currency system will evaluate the values of the items based on proprietary, near real-time market values. The system will then notify the debtor of the values of the items.

The debtor can accept the items he/she wishes to use to pay off part or all of their debt. Once the debtor response has been received regarding evaluation acceptance, the currency system will send back the rejected items and pay the debt holder the amount of the evaluation for the accepted pieces.

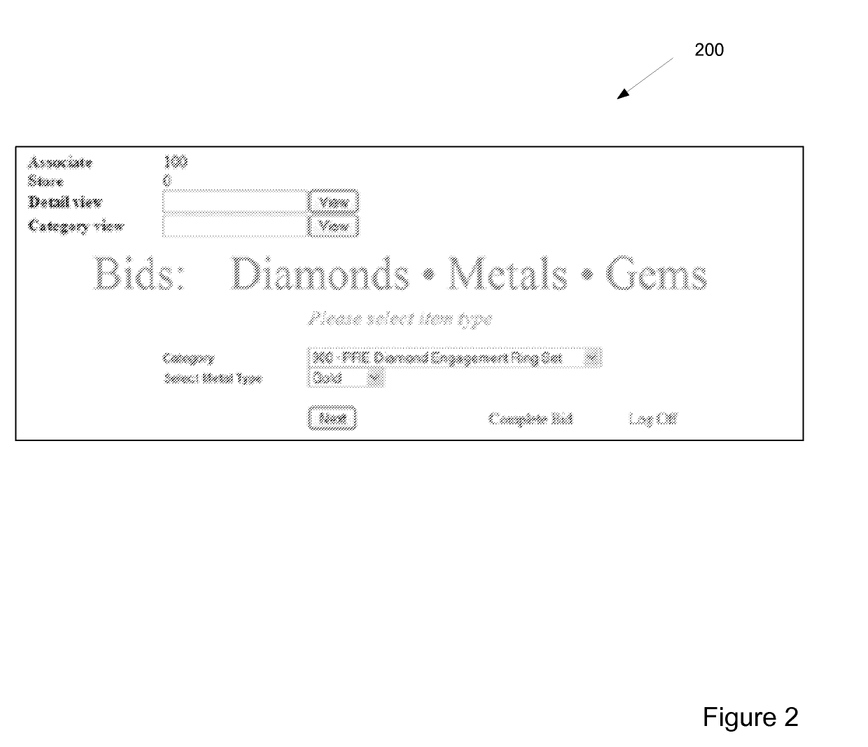

In the example shown, the system evaluates the value of precious gemstones, such as diamonds and rubies, and precious metals, such as gold and silver, using current market values. FIGS. 2-4 illustrate example graphical user interfaces provided on one or more computing devices that facilitate the system's ability to evaluate the value.

For example, precious metals prices can be determined using real time New York Spot prices, and gemstone prices can be determined through aggregate wholesale prices. For example, diamond prices can be determined using real time wholesale market prices. Data is collected from multiple sources. The aggregate data is then cleaned through algorithms that filter out abnormalities and then extrapolates diamond values based on size, cut, color, clarity, shape, fluorescence, certification and other attributes.

As shown in FIG. 2, the evaluation process begins with an evaluator logging into the evaluation website using a graphical user interface 200. The evaluator can select the category that best relates to the precious stone or metal, and the metal composition of the item.

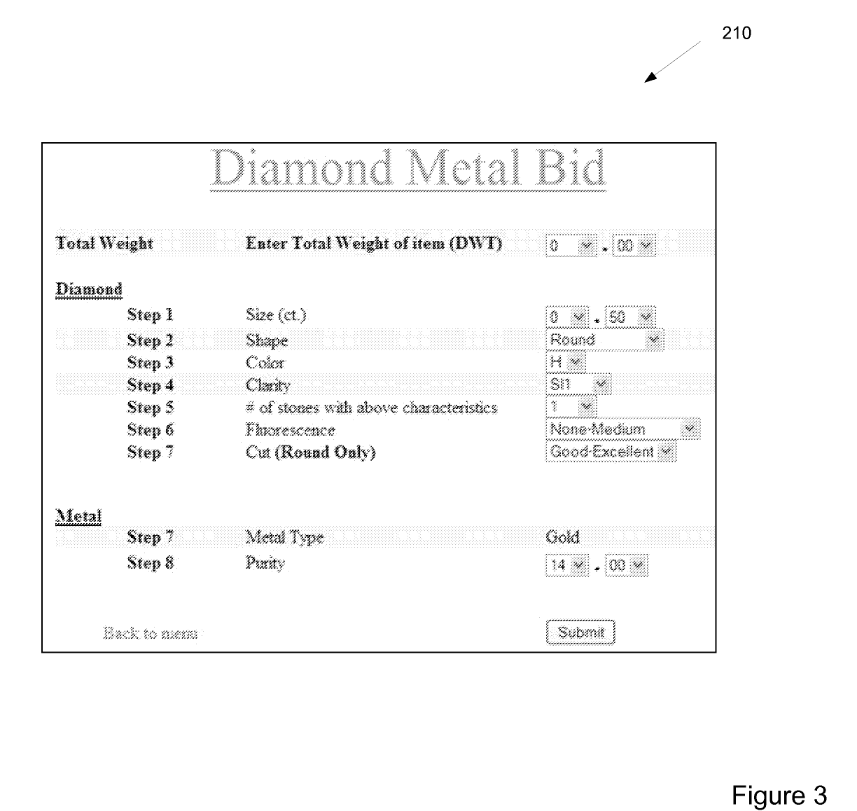

Referring now to FIG. 3, the evaluator can use an interface 300 to measure the metal and precious stone attributes and enter the data into the system. The attributes can include those that are relevant to a given precious metal or gemstone, such as size, shape, color, clarity, fluorescence, cut, etc.

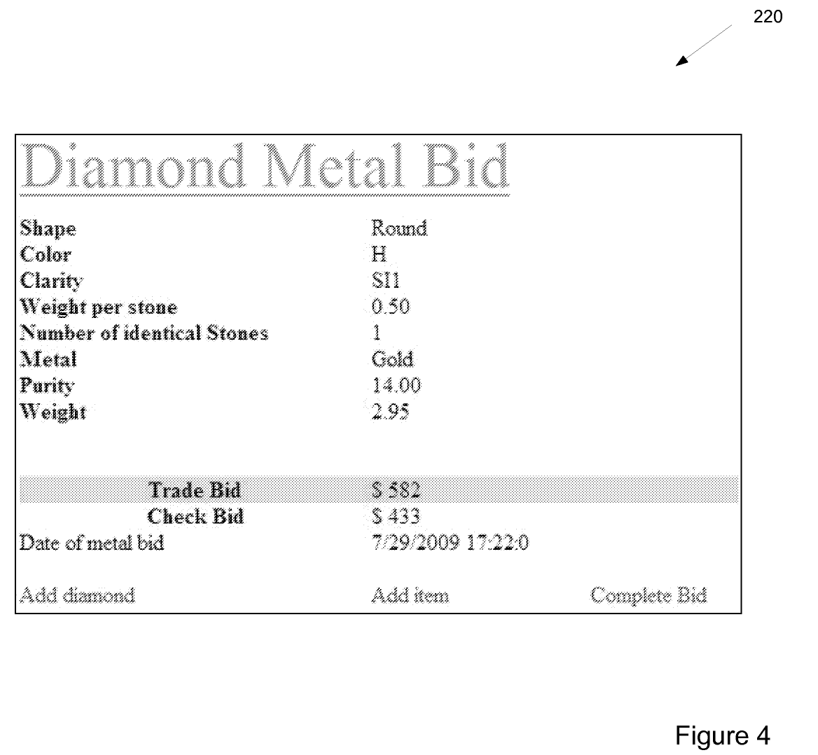

Once the attributes are entered into the system, the system communicates with the database which contains all values for diamonds, gemstones, and precious metals. The prices are determined and the attributes, along with the prices, are reviewed. Once reviewed, a user interface 220 shown in FIG. 4 is generated to show the details of the bid for the particular metal or gemstone.

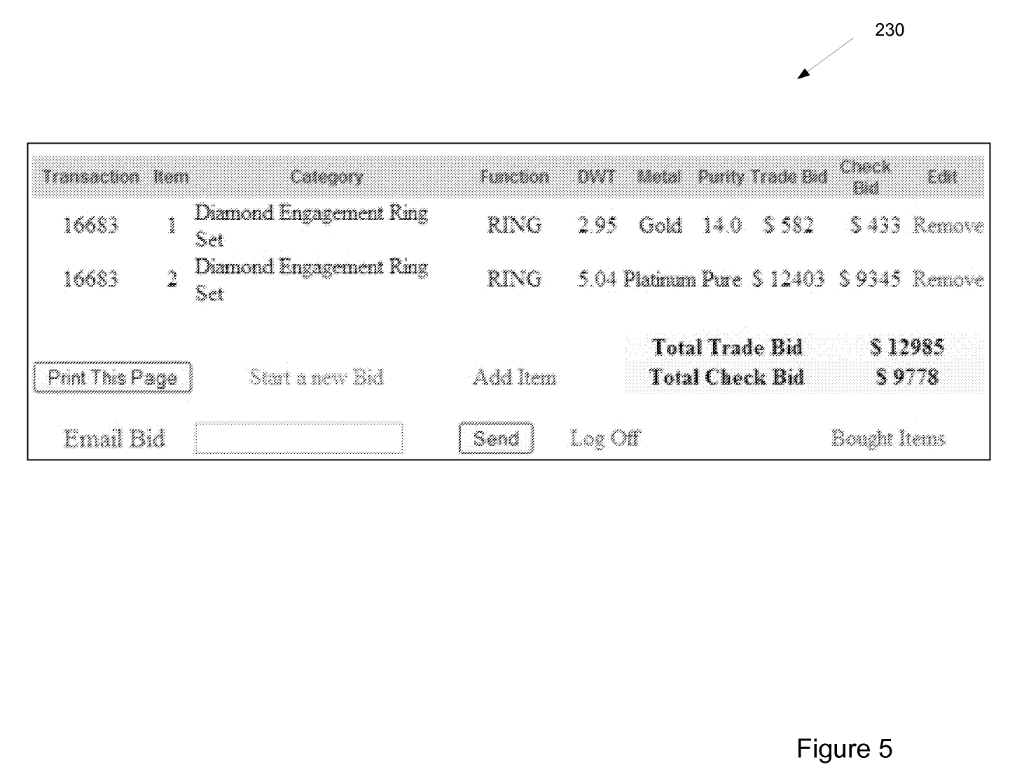

All entered items are now assigned a value to use as currency for payment of debt, in store credit, donation for churches, bills, taxes, or cash. For example, a user interface 230 shown in FIG. 5 shows a listing of bids for two transactions, as well as the totals associated with the transactions.

One or both bids can be communicated to the debtor through various channels, such as by email or paper copy. For example, the bids can be emailed to the debtor, and the debtor can electronically view and accept or deny the bids. If accepted, the debtor's account on the system is credited the appropriate amount that can be used as currency to make payments. If denied, the metal or gemstones associated with the bids are returned.

In some examples, some of the bids can be converted into real time values that are converted into cash immediately. The values are determined through the following process.
Data procurement: The system automatically collects hundreds of thousands of wholesale prices of diamonds being offered for sale from multiple sources. The system continuously updates the data to reflect current market pricing.
Data refinement: Diamond attributes are used to categorize diamonds as a function of dollars per carat. For example, one attribute set could be round shape, E color, VS2 clarity, size between 1.00-1.09, no fluorescence, with very good or better cut. This attribute set could have 100 diamonds for sale across multiple sources. The pool of diamonds for sale is analyzed for abnormalities to remove and finds the most logical lowest price. The system stores the lowest available price and determines the next attributes lowest price. Due to the size of the sample space (# of permutations) there are attribute sets that have no values. In this case, the system freezes all variables, except size, and finds lowest values of lesser and great sizes and uses linear regression to extrapolate the values.
Diamond values: Once the lowest price has been determined for each attribute set for diamonds then the prices are inserted into a database for the system to reference for diamond evaluation. The system will take in shape, color, clarity, cut, size, and fluorescence, find the $/ct for that attribute set, and multiply the value of the diamond by its size. The value reflects the amount of money to be paid for the diamond at the time of evaluation.

In example embodiments, the market system can be configured to discount bids a certain percentage so that the system makes a profit when the metals or gemstones are sold on the open market. In another example, the debtor can pay a fee or percentage to participate in the market system. In yet another example, the debt holder/collections can pay a fee or percentage based on the amount of currency that is used to pay off debits held by the debt holder/collections. Combinations of the same can also be used.

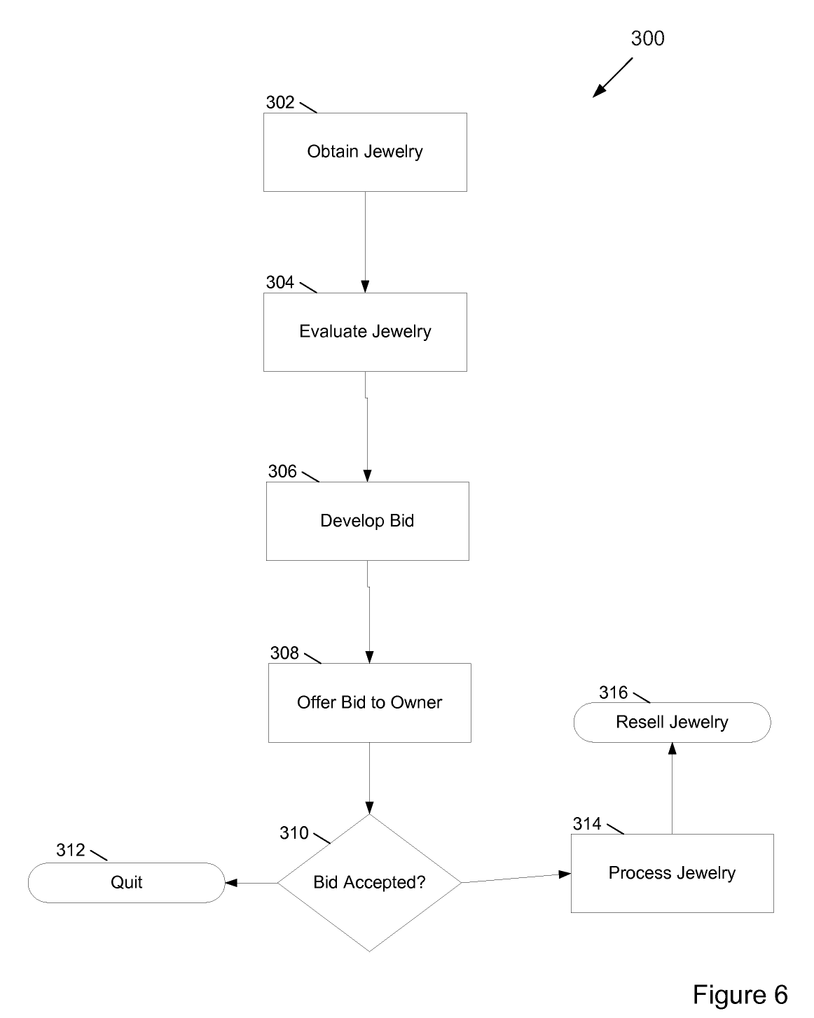

Referring now to FIG. 6, an example method for liquidating jewelry is shown.

Initially, at operation 302, the jewelry is obtained. As described above, one method for obtaining the jewelry is to have the jewelry mailed to the evaluation center. In another example described further below, the jewelry can be brought by an individual to a retail establishment, such as a jewelry store, for evaluation. Other examples are provided below.

Next, at operation 304, the jewelry is evaluated. This evaluation process can be partially or fully automated, as described herein. For example, various attributes associated with the jewelry (e.g., type, size, clarity, etc.) can be obtained.

Next, at operation 306, a bid is developed for the jewelry. As described herein, a bid can be based on the attributes associated with the jewelry. The bid can be automatically generated by the system based on the attributes, as described herein.

At operation 308, the bid is offered to the individual. In one example, this can take the form of an email or hardcopy bid that is provided to the individual. In another example, the individual can simply be orally informed of the bid if the process takes place in a retail establishment.

At operation 310, a determination is made as to whether or not the individual accepts the bid. If not, control is passed to operation 312, and the method terminates.

Otherwise, control is passed to operation 314, and the jewelry is processed. As described further herein, this processing can take the form of sorting the jewelry into categories of qualified and non-qualified jewelry. Qualified jewelry can be resold as-is or after refurbishment. Non-qualified jewelry is jewelry that is broken down into individual components and used to make new jewelry.

Finally, at operation 316, the jewelry is resold, either in a refurbished form or based on the disassembled components.

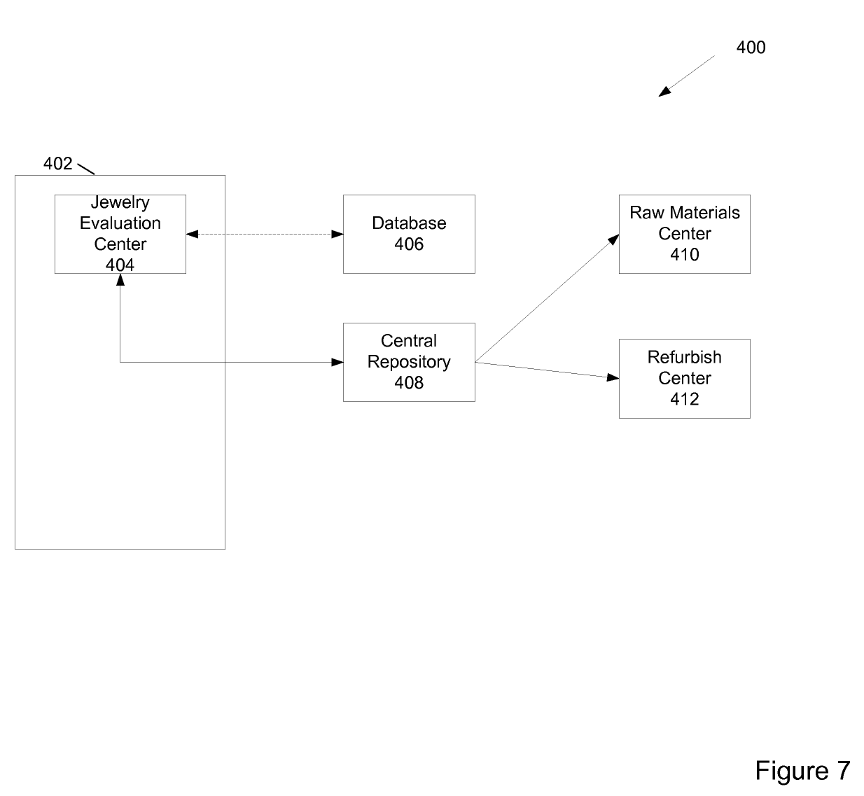

Referring now to FIG. 7, another example system 400 is shown for liquidating jewelry. The system includes a retail establishment 402, a jewelry evaluation center 404, a database 406, a central repository 408, a raw materials center 410, and a refurbish center 412.

The retail establishment 402 can be any brick-and-mortar business, such as a jewelry store or department store. The retail establishment 402 typically sells a plurality of products and services, such as jewelry. Individuals can visit the retail establishment 402 to purchase such goods and services, as well as to liquidate jewelry, as described below.

The jewelry evaluation center 404 is a system located within the retail establishment 402 that allows individuals to liquidate jewelry. The jewelry evaluation center 404 can be integrated and branded as part of the retail establishment 404, or can be a separate entity, such as a kiosk located in the retail establishment 404. Typically, the jewelry evaluation center 404 includes one or more evaluators that are skilled in evaluation of jewelry, as well as one or more computing devices that can accept attributes associated with jewelry and automatically provide bids for the purchase of such jewelry.

In some examples, the jewelry evaluation center 404 can be separately owned and operate in the retail establishment 402 based on an agreement reached with the retail establishment 402. In other examples, the jewelry evaluation center 404 can be owned by or otherwise be associated with the retail establishment 402. In example embodiments, there are multiple jewelry evaluation centers 404 positioned in retail establishments in geographically disperse areas.

The database 406 houses information that assists in developing a bid for each piece of jewelry. For example, the database 406 can include thousands or millions of transactions associated with the sale of jewelry that can be used to develop a bid for a particular piece of jewelry based on the attributes associated therewith. In some examples, the data in the database 406 is updated at periodic intervals, such as every 10 minutes, 1 hour, 2 hours, or 12 hours.

The central repository 408 is a central location where jewelry that is purchased by the jewelry evaluation center 404 is sent. The central repository performs two basic functions, including auditing of the jewelry that is purchased, and deciding how to dispose of the jewelry. For example, as described further herein, jewelry can be disposed of differently depending on whether it is qualified or non-qualified jewelry, as described further below.

The raw materials center 410 accepts non-qualified jewelry. The raw materials center 410 can include one or more facilities that break down jewelry into basic components and process the components such that the components can be used to make new jewelry. For example, the raw materials center 410 can separate a gold band from a diamond setting and melt the gold to be used in a new piece of jewelry. The raw materials center 410 can also clean the diamond in preparation for resetting in a new piece of jewelry. In some examples, the raw materials center 410 can be a plurality of contractors that specialize in specific processes for reclaiming various components from jewelry.

The refurbish center 412 accepts qualified jewelry. The refurbish center 412 can clean or otherwise refurbish jewelry as needed so that it can be resold.

The system 400 is used as follows. Initially, the individual brings one or more pieces of jewelry into the retail establishment 402. The evaluator at the jewelry evaluation center 404 evaluates each piece of jewelry and inputs attributes associated with the jewelry into a computing device, as described herein. The computing device accesses the database 406 to provide a bid for each of the pieces of jewelry.

If the individual accepts any of the bids, the jewelry evaluation center 404 purchases the jewelry from the individual and sends the jewelry to the central repository 408. The central repository audits the bidding process to confirm that an appropriate price was paid for the jewelry. The central repository 408 also determines if the jewelry is to be treated as qualified or non-qualified jewelry.

Generally, qualified jewelry is jewelry that is of a condition that the jewelry can be resold as-is or after refurbishment. Non-qualified jewelry is jewelry of a condition that cannot be resold, so the jewelry is broken into components for processing and resale. For example, if the jewelry is broken or otherwise damaged, it may be categorized as non-qualified. Also, if the jewelry is of a specific size or quality, it may also be categorized as non-qualified. For example, rings having a center diamond of less than a particular size (e.g., 0.5 carats), may be broken into components because the components may be worth more than the assembled jewelry. Other configurations are possible.

Once the central repository 408 finishes processing the jewelry, the jewelry is forwarded to the refurbish center 412 if the jewelry is categorized as qualified, or the jewelry is forwarded to the raw materials center 410 if the jewelry is categorized as non-qualified.

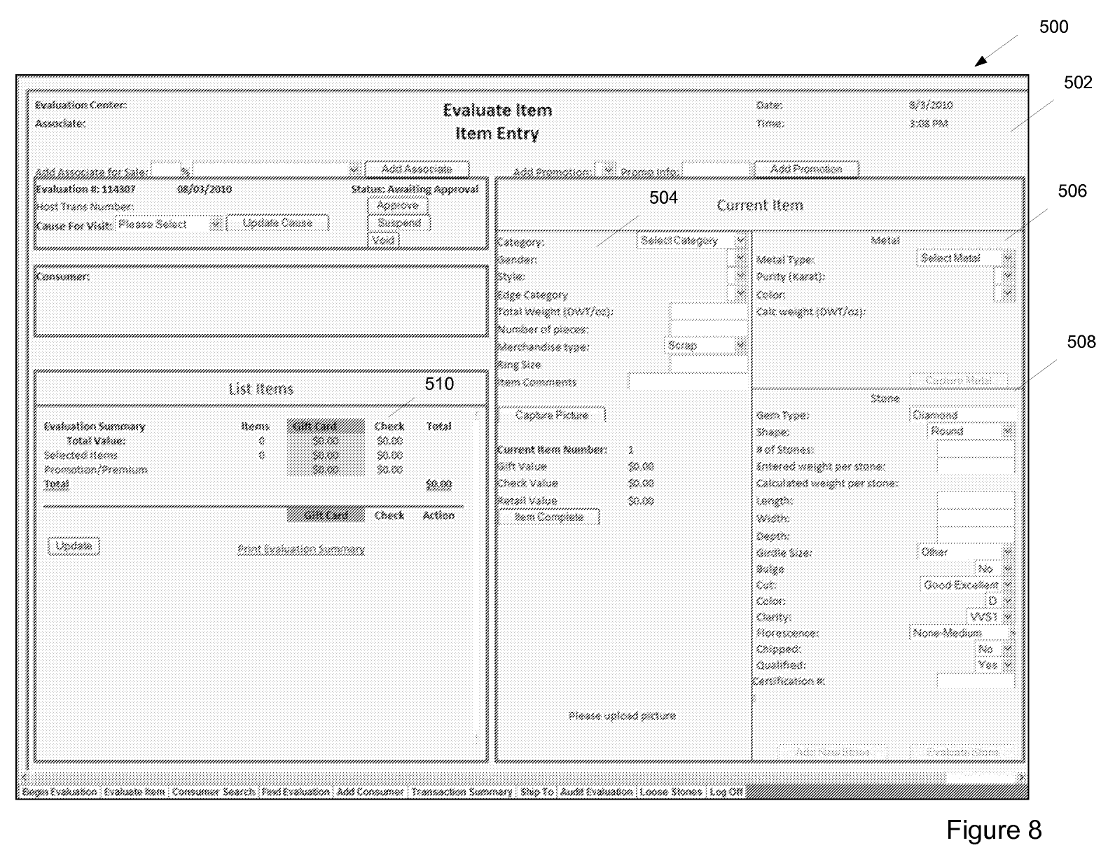

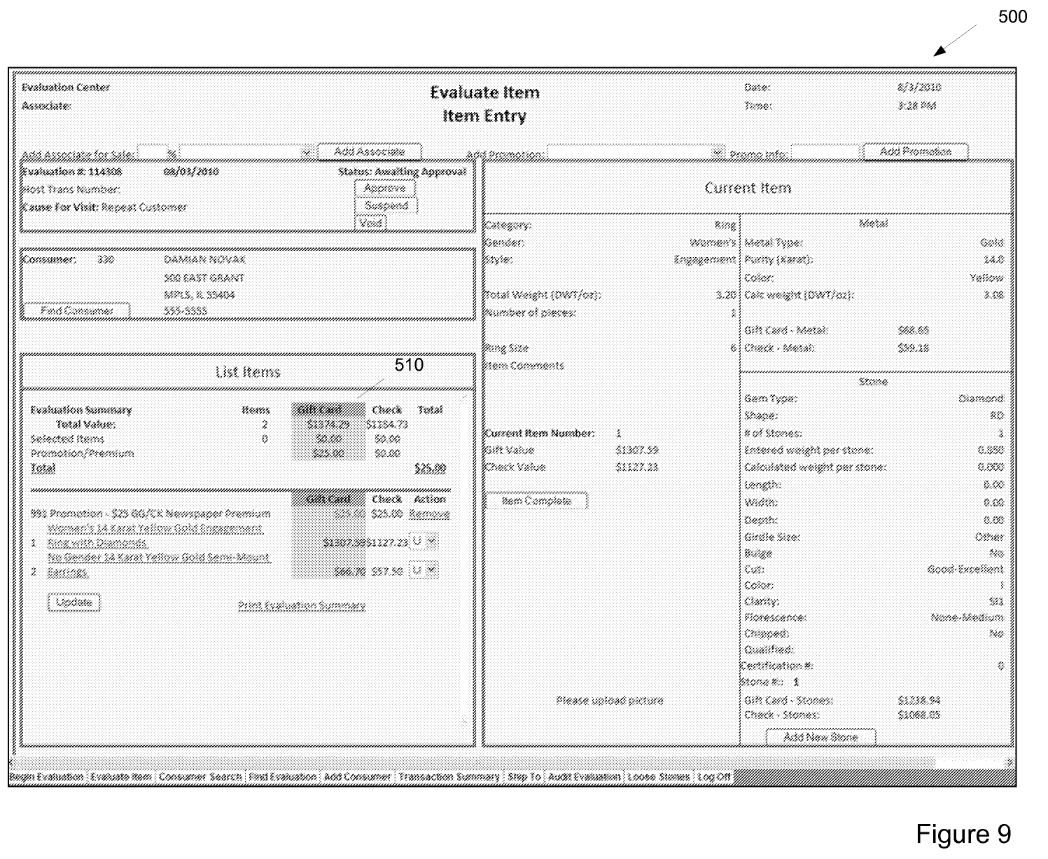

Referring now to FIGS. 8 and 9, another example graphical user interface 500 is shown for evaluating jewelry and automatically providing bids. The user interface 500 is similar to the user interfaces 200, 210, 220, 230 shown in FIGS. 2-5. The user interface 500 can be used by an evaluator at the evaluation center 404 to evaluate a piece of jewelry and provide a bid to an individual.

The user interface 500 includes an identification section 502 in which the evaluator is identified. The user interface 500 also includes sections 504, 506, 508 that allow the evaluator to provide information about the piece of jewelry.

The section 504 allows the evaluator to enter the type of jewelry that is being evaluated, such as ring, necklace, bracelet, earrings, etc. Other type attributes such as sex and total weight are also provided. In addition, the evaluator can categorize the merchandise type as “scrap” (i.e., non-qualified) or qualified.

In addition, the section 504 allows the evaluator to capture an image of the jewelry using a camera, such as a camera connected to the computing device displaying the user interface 500.

The section 506 allows the evaluator to enter the attributes associated with the band of the ring, such as metal type, purity, etc.

The section 508 allows the evaluator to enter attributes associated with any stones on the ring, such as gem type (e.g., diamond, sapphire, etc.), number of stones, etc. In addition, if there are multiple stones of different sizes and/or qualities, the evaluator can select “Add New Stone” to add another stone to the evaluation. Each stone associated with a piece of jewelry can be grouped together in the bid so that a single bid is provided for the piece of jewelry, as shown below.

Once the evaluator has entered all of the relevant information about the jewelry, the evaluator selects the “Item Complete” button in the section 504, and data from the database 406 is used to create a bid.

As shown in FIG. 9, the section 510 provides a summary of the bid based on the information provided by the evaluator. This information can be updated as additional information is provided by the evaluator. In this example, two pieces of jewelry have been evaluated (a ring and earrings), and separate bids are provided for each. Each bid includes an amount if a gift card is issued (e.g., to use at the retail establishment 402 or another store affiliated with the system 400) or cash is given.

In some examples, the system 400 is configured to track buying and selling of jewelry so that the bid amounts are manipulated to optimize the flow of jewelry into and out of the system. For example, as inventories of certain jewelry are depleted (e.g., rings of 1-2 carats), the system can be configured to more aggressively bid on jewelry meeting the depleted category descriptions so that more of that type of jewelry is bought and available for resale. For example, the data in the database 406 can be modified in near real-time to reflect current buy/sell ratios on a plurality of different jewelry items so that the bids given for jewelry are dynamic. In this manner, the demand and supply of the jewelry within the system 400 can be optimized.

In other examples, the jewelry evaluation center 404 can be used in other contexts beyond the retail establishment 402. For example, the jewelry evaluation center 404 can be used to assist in the valuation of jewelry in other context, such as the valuation of estates, in pawn shops for setting appropriate loan values, and for appraisals to be used for insurance purposes. Other applications are possible.

In another embodiment, part or all of the gathering of the attributes of the jewelry by the evaluator can be automated. For example, the imaging of the jewelry can be used to estimate size and weight of the stones. Other devices, such as electronic measuring devices that can measure the content of gold bands can be coupled to the computing device and directly report band content for the bidding process. Other configurations are possible.

In example embodiments, portions or all of the currency system is provided as an online system implemented using one or more computing devices. For example, the currency system and databases can be hosted server computing devices that are accessible by computing devices operated by evaluators, debtors, and debt holders.

In such an example, the evaluators, debtors, and debt holders access the currency system using computing devices. A computing device is a physical electronic computing device. An electronic computing device is a physical machine that comprises physical electronic components. Electronic components are physical entities that affect electrons or fields of electrons in a desired manner consistent with the intended function of an electronic computing device. Example types of electronic components include capacitors, resistors, diodes, transistors, and other types of physical entities that affect electrons or fields of electrons in a manner consistent with the intended function of an electronic computing device.

Examples of such computing devices include personal computers, lap top computers, cellular telephones, video game consoles, netbooks, personal media players, devices integrated into vehicles, television set top boxes, network appliances, server devices, supercomputers, mainframe computers, and other types of electronic computing systems.

A user (i.e., an evaluator, debtor, or debt holder) interacts with the currency system using the computing device. For example, the user may use an input device, such as a keyboard, mouse, pen, voice input device, touch input device, etc., connected to interact with the computing device. Output devices such as a display, speakers, printer, etc. may also be included.

In some examples, the computing devices also include at least one processor or processing unit and system memory. Depending on the exact configuration and type of computing device, the system memory may be volatile (such as RAM), non-volatile (such as ROM, flash memory, etc.) or some combination of the two. System memory typically includes an operating system suitable for controlling the operation of a networked personal computer, such as the WINDOWS® operating systems from Microsoft Corporation of Redmond, Wash. or a server, such as Windows SharePoint Server, also from Microsoft Corporation. The system memory may also include one or more software applications and may include program data.

The computing devices may have additional features or functionality. For example, the devices may also include additional data storage devices (removable and/or non-removable) such as, for example, magnetic disks, optical disks, or tape. Computer storage media may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device.

A network facilitates communication between the computing devices and the computing devices associated with the currency system. The network may be a wide variety of different types of electronic communication network. For example, the network may be a wide-area network, such as the Internet, a local-area network, a metropolitan-area network, or another type of electronic communication network. The network may include wired and/or wireless data links. A variety of communications protocols may be used in the network 108 including, but not limited to, Ethernet, Transport Control Protocol (TCP), Internet Protocol (IP), Hypertext Transfer Protocol (HTTP), SOAP, remote procedure call protocols, and/or other types of communications protocols.

The computing devices associated with the currency system host one or more web pages including, for example, the user interfaces 200, 210, 220, 230, 500 shown in FIGS. 2-5, 8, and 9. As used in this disclosure, a web page is a document displayed by a web browser application when the web browser application renders a web page file. A web page file is a file containing markup language text that defines the content and layout of the web page. In other words, the web page is what the web browser application displays when the web browser application renders a web page file. As used in this disclosure, rendering refers to interpreting markup language text to generate a displayable document. Furthermore, as used in this disclosure, a file is a block of arbitrary information storable on a persistent computer-readable data storage medium. In different implementations, the web page file may contain different types of markup language text. For example, the web page file may contain text conforming to the Hypertext Markup Language (HTML), the Extensible Hypertext Markup Language (XHTML), or another markup language that can be rendered by a web browser application.

The various embodiments described above are provided by way of illustration only and should not be construed to limiting. Various modifications and changes that may be made to the embodiments described above without departing from the true spirit and scope of the disclosure.

What is claimed is:

1. A method for facilitating trading in precious metals and gemstones, the method comprising:
accepting one or more precious metals or gemstones from an individual;
evaluating the precious metals or gemstones to generate a bid using an automated evaluation process;
providing the bid to the individual;
if acceptance of the bid is received from the individual:
assuming ownership of the precious metals or gemstones; and
paying the individual for the precious metals or gemstones; and
if denial of the bid is received from the individual, returning the precious metals or gemstones to the individual.

2. The method of claim 1, further comprising:
crediting the individual's account an amount of currency associated with the bid; and
allowing the individual to use the currency to pay one or more debts.

3. The method of claim 1, wherein generating the bid further comprises:
accepting input of a plurality of attributes associated with the precious metals or gemstones; and
accessing a database to set the bid for the precious metals or gemstones.

4. The method of claim 3, further comprising:
accepting separately attributes about each of the precious metals or gemstones that form a piece of jewelry;
accessing the database for each of the precious metals or gemstones; and
providing the bid for an entirety of the piece of jewelry.

5. The method of claim 3, further comprising periodically updating the database to reflect changes in pricing for the precious metals or gemstones.

6. The method of claim 1, further comprising locating an evaluation center in a retail establishment.

7. The method of claim 6, further comprising providing evaluation services separate from the retail establishment.

8. The method of claim 1, further comprising capturing an image of the precious metals or gemstones.

9. The method of claim 1, further comprising categorizing the precious metals or gemstones as qualified or non-qualified jewelry.

10. A method for purchasing jewelry, the method comprising:
accepting jewelry from an individual;
evaluating the jewelry to generate a bid using an automated evaluation process including:
accepting input of a plurality of attributes associated with the jewelry; and
accessing a database to set the bid for the jewelry;
providing the bid to the individual;
if acceptance of the bid is received from the individual:
assuming ownership of the jewelry; and
paying the individual for the jewelry; and
if denial of the bid is received from the individual, returning the jewelry to the individual.

11. The method of claim 10, further comprising:
crediting the individual's account an amount of currency associated with the bid; and
allowing the individual to use the currency to pay one or more debts.

12. The method of claim 10, further comprising:
accepting separately attributes about each precious metal or gemstone of the jewelry;
accessing the database for each precious metal or gemstone; and
providing the bid for the jewelry.

13. The method of claim 10, further comprising periodically updating the database to reflect changes in pricing for the jewelry.

14. The method of claim 10, further comprising locating an evaluation center in a retail establishment.

15. The method of claim 14, further comprising providing evaluation services separate from the retail establishment.

16. The method of claim 10, further comprising capturing an image of the jewelry.

17. The method of claim 10, further comprising categorizing the jewelry as qualified or non-qualified.

18. The method of claim 17, further comprising breaking the non-qualified jewelry into components.

19. The method of claim 17, further comprising reselling the qualified jewelry.

20. A computer-readable data storage medium storing computer-readable instructions that, when executed by one or more processing units of a computing system, cause the computing system to:
accept input of a plurality of attributes associated with the jewelry;
access a database to set a bid for the jewelry; and
provide the bid for purchase of the jewelry.
